(19) United States
(12) Patent Application Publication
(10) Pub. No.: US 2025/0138520 A1
(43) Pub. Date: May 1, 2025

(54) METHODS FOR DIAGNOSING AND AUDITING CONTROL LOOPS AND METHOD FOR COMPARING THE PERFORMANCE OF A CURRENT CONTROL LOOP

(71) Applicants: PETRÓLEO BRASILEIRO S.A. – PETROBRAS, Rio de Janeiro (BR); UNIVERSIDADE FEDERAL DO RIO GRANDE DO SUL - UFRGS, Porto Alegre (BR)

(72) Inventors: Fabio Cesar DIEHL, Rio de Janeiro (BR); Murilo Becher DEWES, Porto Alegre (BR); Leonardo Mandler DE MARCO, Porto Alegre (BR); Marcelo FARENZENA, Porto Alegre (BR); Jorge Otávio TRIERWEILER, Porto Alegre (BR)

(73) Assignees: PETRÓLEO BRASILEIRO S.A. – PETROBRAS, Rio de Janeiro, RJ (BR); UNIVERSIDADE FEDERAL DO RIO GRANDE DO SUL - UFRGS, Porto Alegre, RS (BR)

(21) Appl. No.: 18/926,033

(22) Filed: Oct. 24, 2024

(30) Foreign Application Priority Data
Oct. 31, 2023 (BR) 1020230228135

(51) Int. Cl. G05B 23/02

(52) U.S. Cl. CPC G05B 23/024; G05B 23/0294

(57) ABSTRACT

The present invention refers to an audit method and a diagnostic method in industrial control loops through the detection of oscillations in time series originating from the control action and the controller output, through a technique based on autocorrelation, wherein an Input-Output Cross Autocorrelation Diagram (IOCAD) is developed to monitor the performance of control loops. Specifically, with the sensor signal of the manipulated variable (MV) and the sensor signal of the controlled variable (PV), autocorrelations of the MV and PV are calculated, generating the IOCAD. In this way, indicators are generated that allow auditing and diagnosing control loops. The invention further relates to a method for comparing the performance of a current control loop with a reference control loop through the IOCAD.

### CROSS-REFERENCES TO RELATED APPLICATIONS

This application claims the benefit of priority to Brazilian Patent Application No. 1020230228135 filed Oct. 31, 2023, the contents of which are hereby incorporated by reference in their entirety for all purposes.

### FIELD OF THE INVENTION

The present invention pertains to the technical field of engineering, process control and monitoring of industrial processes, specifically, to compare the performance of a control loop in relation to a reference model, diagnosing a problem found in the control loop: cause, oscillation detection, control loop performance, or controller tuning problem.

### Backgrounds of the Invention

Due to the incidence of oscillations in control loops and their economic impact, oscillation detection methods have received great attention (Dambros, Trierweiler and Farenzena, 2019). In general, process industries have between 500 and 5000 control loops, making visual inspection of an entire process unfeasible (Desborough and Miller, 2002). Accordingly, the automation of the oscillation detection becomes necessary.

It is reported that oscillations affect around 30% to 41% of the control loops, being one of the most frequent problems in process control (Bauer et al., 2016; Bialkowski, 1993; D. Ender, 1993; Torres et al., 2007). Control loops consist of a sensor to measure the process variable (PV) that is to be controlled, a controller, which tunes the process signal to a setpoint and produces a control action that changes the manipulated variable (MV) so that the process variable reaches the setpoint. The presence of oscillation is an indication of a deterioration in performance and a loss of stability in the control loop. Therefore, the oscillation diagnosis is essential to evaluate the performance of the control loop (Babuska, Ast, Van and Mesid, 2006).

Industrial data contains different characteristics relating to the dynamics of the process, such as cause of oscillation, measured variable (pressure, flow rate, for example); therefore, the development of an automatic oscillation detection technique for industries is not a simple task (Dambros, et al., 2019a). Among the most used methods, autocorrelation is an attractive method, as the autocorrelation of an oscillatory signal is also oscillatory with the same period as the oscillation in the time domain (Naghoosi and Huang, 2014). The benefit of using autocorrelation for oscillation detection is that the impact of noise is reduced, as white noise (common in industrial sensors) has approximately zero autocorrelation for offsets greater than zero (Thornhill, Huang, and Zhang, 2003). Another benefit is the normalized signal of autocorrelation, as the autocorrelation ranges from −1 to 1, wherein −1 means the signal is negatively autocorrelated and 1 means the signal is positively autocorrelated.

Dambros, Trierweiler and Farenzena (2019) reviewed more than fifty works related to the field of oscillation detection. The authors organized them into groups, with 18 works addressing to the detection of plant-wide oscillation, in which a set of time series of control loops are analyzed in parallel with the aim of recognizing that the oscillation in a control loop propagates for other control loops.

Dambros, Trierweiler and Farenzena (2019) gathered another 38 documents that address to individual detection for each time series. The documents are divided into techniques based on time domain, autocorrelation function, frequency domain, continuous wavelets and decomposition. All these techniques brought together by Dambros, Trierweiler and Farenzena (2019) are rule-based.

Among the techniques based on and made available by scientific literature that use the autocorrelation technique to detect oscillation, the technique proposed by Hăgglund (1994) is known as the first technique for automatic detection of oscillation. The method consists of computing the integral of the absolute error (IAE) between each zero crossing. If the IAE value is greater than the defined limit, a counter is added; if the counter passes a specific value, the oscillation is confirmed. The choice of this limit is based on the signal cutoff frequency or the controller integral time. Joining techniques based on the autocorrelation function, Seborg and Miao (1998) present a technique that evaluates the decay rate of the autocorrelation function. If the value exceeds a certain limit, the oscillation is detected. As an advantage, the procedure identifies non-persistent oscillations. The method proposed by Thornhill, Huang and Zhang (2003) is widely used; recent documents such as Zhou, Chioua and Schlake (2017), Bauer et al. (2019) and Nindyasari et al. (2021) employ this method to detect oscillations in time series. Dambros et al. (2019b) present that the technique proposed by Thornhill, Huang and Zhang (2003) is not suitable for non-stationary oscillatory series, as it is based on the number of times the autocorrelation function crosses the axis. In non-stationary oscillatory time series, the autocorrelation function will also be a non-stationary oscillatory series; therefore, the number of times the function crosses the axis is affected.

Furthermore, Thornhill, Huang and Zhang (2003) developed a method for detecting oscillation through the regularity of crossing the axis of the autocorrelation function, with the aim of identifying oscillations with different frequencies. To achieve this, the technique requires the use of a band-pass filter to isolate components with different frequencies. This poses some disadvantages; for example, the band-pass filter needs to be tuned for each time series and using the filter can add artificial oscillations. To correct this, Naghoosi and Huang (2014) presented a method that directly identifies multiple oscillations in the autocorrelation function without requiring signal processing. The method is based on separating peaks with similar amplitude into groups and calculating the regularity of each group. Karra and Karim (2009) proposed decomposing the time series by isolating the dominant frequencies using a band-pass filter. As a disadvantage, the method proposed by Karra and Karim (2009) requires bias removal, normalization of the time series to zero average and unity gain, and a band-pass filter with a frequency of 0.02 to 0.99 Hz/Hz. Srinivasan, Nallasivam and Rengaswamy (2011) presented the parametric Hammerstein model for detection of grasping in control action and the non-parametric analysis of the Hilbert-Huang spectrum for distinguishing between poorly tuned control loops and disturbances that cause oscillations. Some other techniques can be cited, such as the one proposed by Wardana (2016), which introduces the method based on variational mode decomposition, Dambros et al. (2019a) that uses Machine Learning techniques, and Wang and Zhao (2020) that use the slow feature analysis method to detect oscillation in time series.

Regarding the oscillation detection in real time, Salsbury and Singhal (2005) stand out, who present an oscillation detection technique based on the estimation of the poles of the ARMA model. Selecting the correct model order is one of the limitations of the technique. Babuska, Ast, Van and Mesid (2006) proposed the first frequency-based automatic technique. The method requires knowledge from the engineer to train a fuzzy logic model, which is a disadvantage. Wang, Huang and Lu (2013) applied the discrete cosine transform to 1000 time series of industrial processes. Despite having satisfactory results, in many cases the technique presents a significant rate of false positives. Guo et al. (2014) proposed an online decomposition method based on intrinsic time-scale decomposition, which is robust to multiple, intermittent, non-stationary oscillations or setpoint changes. Xie et al. (2016) developed a method using intrinsic time-scale decomposition with robust clustering of zero-crossing intervals. The technique aims at being able to address to multiple oscillations and intermittent oscillations.

Ferreira (2006), among the so-called first 8 documents referring to the audit of control loops, uses the autocorrelation function to evaluate the controller performance. The technique consists of evaluating the slope of the autocorrelation function of the controller associated with the real plant with the slope of the autocorrelation function of the controller associated with the ideal plant. This document presents situations with the presence of disturbance, variation in dead time, variation in the order of the plant, variation in the dynamics of the disturbance, variation in the location of the plant's transmission zero and, finally, the method is applied in a plant having three spherical tanks. The results obtained using the output autocorrelation function for auditing controllers were satisfactory, but only the output signal was used in the autocorrelation analysis.

Gao et al. (2017) proposed a new method to simultaneously audit the control loop and correctly tune the PID (Proportional Integral Derivative) controller. The proposed technique only requires the PID controller parameters and a set of control loop data with setpoint changes, while it is not necessary to know the process model nor does it need to identify the same. To this end, an index relating the integral of the squared error (ISE) and the total squared variation (TSV) of the control action is presented, providing information necessary for monitoring the control loop. A reference model is still needed to describe the desired response of the control loop, unlike this invention.

Just like the approach of Gao et al. (2017), Moreira, Acioli Junior and Barros (2018a) developed a technique for auditing control loops using the frequency domain. The PID controller retuning method aims at making the process model correspond to the reference model using a convex optimization that minimizes the cost function. The documents by Moreira, Acioli Júnior and Barros (2018b), Moreira, Acioli Junior and Barros (2018c) and Moreira et al. (2021) are similar, having the same disadvantages as Gao et al. (2017).

Francisco, Trierweiler and Farenzena (2019) present a PID controller autotuning approach based on minimizing the nominal error, a reference to determine whether the model is discrepant with the plant and consequently associated with poor controller tuning. First, the control loop is audited to check whether the cause of poor performance is the discrepant model; then, an autotuning is proposed to find the new ideal parameters for the controller at the new operating point. Therefore, the document proposed by Francisco, Trierweiler and Farenzena (2019) requires a reference model to audit the control loop.

With a similar approach to those described above, Yu and Li (2021) developed a one-dimensional search algorithm to obtain a better estimate of the process's dead time. An approach based on integral equation is extended for use in auditing the responses of the general process control loops. In the algorithm architecture, it is necessary to approximate the real process model to a first order plus dead time model, or a second order plus dead time model. The present invention, in order to audit the control loop, does not require approximation of the real model to a first or second order model.

In a slightly different way from the documents cited regarding control loop auditing, Zhang, Zhao and Zhang (2021) adapt the PID controller auditing method based on the ISE-TSV indicator using a new neural dynamics. Initially, the ISE-TSV indicator is applied to evaluate the performance of the PID controller, while the neural network aims at finding the new optimal parameters of the PID controller. The present invention does not use neural networks in its methodology, being different from the document presented by Zhang, Zhao and Zhang (2021).

In this sense, observing the limitations of the State of the Art, there was a need for a method that jointly analyzed the autocorrelation of the control action and the autocorrelation of the process variable, generating an Input-Output Cross Autocorrelation Diagram (IOCAD), in which the input is the control action and the output is the process variable. Using this diagram, it is possible to audit the control loop and check whether there is a loss of robustness (oscillation in the control action), loss of performance (oscillation in the process variable), or loss of controllability (oscillation in both input and output). An indicator, based on the Integral Time-Weighted Absolute Error (ITAE), is used together with the R² determination coefficient; the variance of the autocorrelation error and Levene's statistical test as a metric make possible to determine the loss of performance of the control loop as the oscillations of the control action and process output increase. This diagram combined with the indicator proposed by the present invention is capable of establishing the effectiveness of the control loop in real time; for this, a moving window is used, without the need for visual inspection. In addition, the present invention is applicable to both oscillatory and non-oscillatory time series and to stationary and non-stationary time series. The explanation is because in a control loop with good performance, the autocorrelations of the control action and the process variable tend to zero, and as the control loop loses performance, the oscillation increases in the time series, being possible to verify in the IOCAD, while the oscillation is quantified using the ITAE criterion, R², the variance of the autocorrelation error, and Levene's statistical test.

In view of this, and in order to solve the technical problems described above, with the present invention a reference model is not necessary to determine the loss of performance of the control loop. Although this invention does not require a reference model for the control loop, it is possible, from the controller data, to approximate a reference model for the controller and compare the performance of this model with real process data through IOCAD to check the performance of the control loop. If the performance of the real control loop is far from the reference control loop, it is possible to determine a loss of controller performance. For these cases, the IOCAD is able to provide information whether the controller is performing better or worse than expected/projected for the real process.

### STATE OF THE ART

In the State of the Art, there are methods to evaluate the performance of the control loop; however, such methods present deficiencies when compared to the method of the present invention, as the documents do not use the manipulated variable or control action of the control loop, and mainly, they do not present an Input-Output Cross Autocorrelation Diagram like the present invention, in addition to not requiring a reference model to determine the loss of performance of the control loop.

Patent document US20130226348A, for example, describes that in order to maintain optimal performance of the offshore platform, the performance of the control loop must be maintained within certain design specifications. This can be achieved by monitoring loop performance and taking appropriate corrective action when a poor performance is detected. However, detecting, diagnosing, and solving these problems can be difficult, particularly on large and complex offshore platform systems. The performance of control loops is monitored using data-based methods. Data analysis is intended to enable the identification of various aspects of poor control and to generate a list of problematic loops with diagnoses of the individual problems so that the problems can be prioritized and corrected.

Patent document U.S. Pat. No. 5,691,896A describes a method of determining the tuning parameters of a process control system that controls a process through a control output signal, as a function of a measured process variable and a setpoint. The method comprises varying the control output signal over time, so that the measured process variable increases and decreases; determination of an ascending dead time LR in the measured process variable; determination of an ascending rate of change RR in the measured process variable; determination of a decreasing dead time LF in the measured process variable; determination of a decreasing rate of change RF in the measured process variable; and tuning of process control system function based on LR, LF, RR and RF.

Document JP5096358B2 relates to the measurement of the process control loop signal data generated as a result of normal operation of one or more process control devices within an adaptive process control loop, when the adaptive process control loop is connected (online) in a process control environment to asynchronously diagnose each component of the adaptive process control loop from process control loop signal data. It generates a plurality of diagnostic indicators associated with process control loop parameters, for each adaptive process control loop component, from process loop signal data. The method of diagnosing an adaptive process control loop includes: evaluating a state of the adaptive process control loop from one or more diagnostic indicators. Generating a plurality of process control loop parameters from the process loop signal data includes generating the process control loop parameters individually for each adaptive process control loop component.

Document U.S. Pat. No. 5,719,788 addresses to a method for detecting oscillations in control loops using autocorrelation of controlled variable data. The technique consists of generating a decay rate of the autocorrelation function and determining whether there is oscillation in the controlled variable.

Document CN103970124A consists of a method for online detection of the oscillatory behavior of an industrial control loop based on the collection of a set of process data in real time. The method used is similar to that proposed by Guo et al. (2014) and by Xie et al. (2016).

Document CN105607477A presents a technique for detecting oscillation in control loops based on improved local average decomposition; to do this, it uses the control loop output signal (controlled variable).

Document CN109669440A addresses to a technique for detecting intermittent oscillation based on noise. The control loop output signal is decomposed using a technique similar to that presented by Guo et al. (2014) and by Xie et al. (2016).

Document CN111624979A addresses a method for detecting oscillation in control loops using controlled process variables. The technique used is similar to that presented by Wang and Zhao (2020).

Finally, document KR20200048743A addresses to a method for detecting oscillation in a control loop using the Fast Fourier Transform. The Fast Fourier Transform is applied to the controlled variable and then the existence or not of oscillation is determined.

The present invention differs from the State of the Art, as it presents a method that simultaneously uses input and output autocorrelations; it presents the input-output cross autocorrelation diagram (IOCAD), which is capable of providing information for auditing and diagnosing control loops; and it is computationally efficient, simple to implement in real time (uses a moving window to estimate IOCAD); it does not require a reference model or model identification; it is able to diagnose whether the control loop components (control action and process variable) are oscillating together or just one of them is oscillating; by using autocorrelation to detect oscillation, white noise is filtered and data is normalized; it allows the perception of loss of operational controllability over time; and it is not necessary to know the signal frequency.

### BRIEF DESCRIPTION OF THE INVENTION

The present invention refers to a method for auditing and diagnosing control loops, through the detection of oscillations (indicative of poor performance), comprising the following steps: (a) determining the size of a moving window for collecting data of a manipulated variable (input) and a controlled variable (output); (b) removing a bias from the input and output signal; (c) calculating an autocorrelation function for the input and output data in the given moving window; (d) creating an Input-Output Cross Autocorrelation Diagram (IOCAD) and evaluating whether the points are scattered within the confidence region or outside the confidence region, and (e) applying an ITAE criterion, R², autocorrelation error variance and statistical tests, such as Levene's statistical test, to quantify the performance of the control loop. Optionally, it is possible to use a fourth-order low-pass filter in measurements that present strong noise. In step (e), said statistical tests comprise Levene's statistical tests that quantify the performance of the control loop. The Input-Output Cross Autocorrelation Diagram (IOCAD) created in step (d) comprises an input, which is the control action, and an output, which is the process variable. The method uses a moving window in the input data (manipulated variable) and output data (controlled variable) of the control loop. Furthermore, the method uses a low-pass filter in cases with strong measurement and process noise in the moving window in the input data (manipulated variable) and output data (controlled variable) of the control loop. The method comprises calculating an autocorrelation function of input data (manipulated variable) and output data (controlled variable) of the control loop. The Input-Output Cross Autocorrelation Diagram generated in step (d) consists of an axis representing the input autocorrelation and another axis representing the output autocorrelation. In step (c), there are calculated the error between the input autocorrelation and its confidence interval and the error between the output autocorrelation and its confidence interval. Furthermore, in step (c), there is calculated the integral of the time-weighted error between the input autocorrelation of the control loop and its confidence interval, called ITAE of the input, and additionally, there is calculated the integral of the time-weighted error between the control loop output autocorrelation and its confidence interval, called ITAE of the output. The method further comprises defining in step (e) a limit ITAE value. The method additionally comprises calculating the R² between the control loop input autocorrelation and the IOCAD input autocorrelation axis called input R²; and calculating the R² between the control loop output autocorrelation and the IOCAD output autocorrelation axis called output R². The method defines in step (e) a limit R² value. Furthermore, it comprises calculating the variance of the input autocorrelation error of the control loop, called input autocorrelation error variance; and calculating the output autocorrelation error variance of the control loop, called output autocorrelation error variance. Additionally, the method defines a limit autocorrelation error variance value. It also comprises calculating statistical tests, such as Levene's statistical test of homogeneity, between the input autocorrelation of the control loop and the input autocorrelation axis of the IOCAD, called p value of the input, and between the output autocorrelation of the control loop and the IOCAD output autocorrelation axis, called the p value of the output.

The method further defines a limit p value for statistical tests. In addition, the method comprises comparing the ITAE value of the input and/or output with the limit ITAE, the R² of the input and/or output with the limit R², the variance between the autocorrelation error of the input and/or output with the variance limit and the p value of the input and/or output with the limit p value; wherein, if both values are above the respective limits, the oscillation in the manipulated and/or controlled variable is detected. The invention further comprises a method for comparing the performance of a current control loop, comprising comparing the performance of the current control loop, comprised of a controller and a real plant model, with a reference control loop, consisting of said controller and a reference plant model. The performance of the reference control loop is obtained through simulations, which comprises the following steps: (a) obtaining, from the controller parameters, a reference plant model with a controller tuning technique and obtaining through simulation the reference control loop output signal; (b) determining the size of the moving window for collecting data of the manipulated variable (input) and the controlled variable (output) from the control loop and the reference control loop; (c) using a fourth-order low-pass filter, optionally, in measurements that present strong noise; (d) calculating the autocorrelation function for the input and output of the control loop and the reference control loop; (e) creating IOCAD and comparing the performance of the real control loop with the reference control loop; (f) applying an ITAE criterion quantifying the discrepancy between the real control loop and the ideal control loop; and (g) calculating the area of the real ITAE value and the area of the reference ITAE value by comparing the performance through the KPI. The method further comprises obtaining a reference plant model from controller parameters using a controller tuning technique, and the performance of the reference control loop is obtained through simulations. It uses a moving window on the input data (manipulated variable) and output data (controlled variable) of the control loop. The method additionally comprises calculating an autocorrelation function of the input data (manipulated variable) and the output data (controlled variable) of the control loop. Furthermore, the method calculates a confidence interval for the input autocorrelation function and the output autocorrelation function of the control loop. The created Input-Output Cross Autocorrelation Diagram comprises an axis that represents the input autocorrelation and another axis that represents the output autocorrelation. The method further comprises calculating an error between the input autocorrelation and its confidence interval and the error between the output autocorrelation and its confidence interval. Furthermore, the method calculates an integral of the time-weighted error between the input autocorrelation and its confidence interval, called ITAE of the input, and calculates an integral of the time-weighted error between the output autocorrelation and its confidence interval, called ITAE of the output. The method comprises calculating an integral of the time-weighted error between the input autocorrelation of the reference control loop and its confidence interval, called ITAE of the reference input, and calculating an integral of the time-weighted error between the output autocorrelation of the reference control loop and its confidence interval, called ITAE of the reference output. The method calculates an ITAE area of the input and output upon change of setpoint, disturbance, or change of setpoint plus disturbance. In addition, the method calculates an area of the ITAE of the reference input and output upon a change of setpoint, a disturbance or a change of setpoint plus disturbance. Finally, the method comprises calculating a KPI to determine whether the manipulated variable and/or controlled variable of the control loop has superior, inferior, or similar performance to the reference control loop. This makes it possible to audit and diagnose the quality and representativeness of the plant model.

### BRIEF DESCRIPTION OF THE FIGURES

In order to complement the present description and obtain a better understanding of the features of the present invention, and in accordance with a preferred embodiment thereof, in the annex, a set of figures is presented, in an exemplifying, although not limiting, manner.

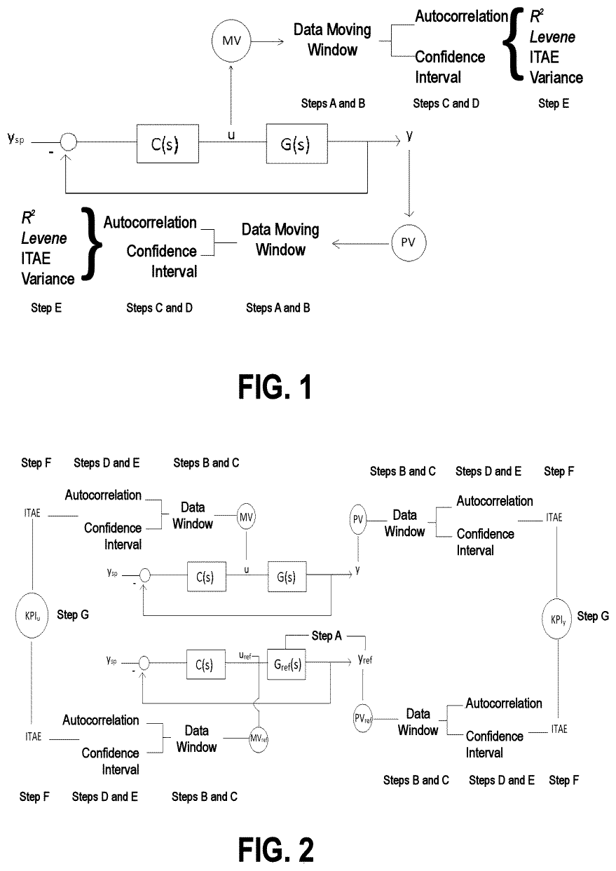

In FIG. 1, there are represented a control loop and steps of the method for auditing and diagnosing based on the detection and quantification of oscillations, in which u represents the manipulated variable (input), y the controlled variable (output), ysp the setpoint, C(s) the controller and G(s) the plant, according to a preferred embodiment of the present invention.

In FIG. 2, there are represented a control loop and a reference control loop, in which u represents the manipulated variable (input), u_{ref} represents the manipulated variable in the reference control loop (reference input), y the variable controlled (output), y_{ref} the controlled variable in the reference control loop (reference output), ysp the setpoint, C(s) the controller, G(s) the plant, G_{ref}(s) the reference plant model obtained through the controller parameters C(s), and method steps for performance comparison, in accordance with a preferred embodiment of the present invention.

### DETAILED DESCRIPTION OF THE INVENTION

The following descriptions are presented by way of example, not limiting the scope of the invention, and will allow a clearer understanding of the object of the present patent application. The invention can be applied to all types of control loops, as it is based on the principle that the presence and/or increase in oscillation is an indication of loss of performance of the control loop.

As mentioned previously, the present invention aims at auditing and diagnosing control loops. A control loop is presented in FIG. 1.

To monitor the oscillation in the control loop, the autocorrelation function is used to check the progress of the oscillation in the control action (input) and in the process variable (output). This monitoring is possible, as the autocorrelation of an oscillatory signal is also oscillatory with the same period. The autocorrelation function is presented below, in Equation 1.

$${r}_{k} = \frac{\text{?} ( \text{?} - \overline{y} ) \text{?} - \overline{y} )}{\text{?} {( \text{?} - \overline{y} )}^{2}} \qquad ( 1 )$$

$$\text{?} \text{indicates text missing or illegible when filed}$$

where rₖ is the autocorrelation at displacement k, the measurements y₁, y₂, . . . , yₙ, at times t₁, t₂, . . . , tₙ. The maximum displacement evaluated is equal to half the length of the data moving window.

From the input and output autocorrelation, the Input-Output Cross Autocorrelation Diagram (IOCAD) is presented. The IOCAD is created using a scatterplot between input and output autocorrelation.

For the audit and diagnosis of control loops in IOCAD, a region of confidence is defined, in which it is considered that the data is not autocorrelated. In a well-performing control loop, data must be scattered within the region of confidence in the IOCAD. The confidence interval is given by Equation 2 below.

$$\text{?} = \text{?} √ \frac{1}{n} ( 1 + 2 \text{?} ) \qquad ( 2 )$$

$$\text{?} \text{indicates text missing or illegible when filed}$$

where n is the dimension of the collected data vector, z is the normal distribution and a is the significance level. The significance level used is 95% and the confidence interval changes according to the size of the data window.

The IOCAD is a scatterplot constituted through the autocorrelation of the control action versus the autocorrelation of the process variable. For a control loop with good performance, the data will be scattered within the confidence region in the IOCAD. If the oscillation is present only in the control action, the data will be scattered in the IOCAD only in the input autocorrelation axis, diagnosing the loss of robustness of the control loop. On the other hand, if the process variable has oscillation, the data will be scattered only in the output autocorrelation axis in the IOCAD, demonstrating the loss of controller performance. Finally, if the loss of operational controllability of the control loop is presented, there is oscillation present in both the control action and the process variable. In this case, the points are scattered diagonally.

To assist in identifying the oscillation, a 45 degree straight line is added to the IOCAD, representing the diagonal of the diagram.

Data outside the region of confidence is an indication of poor performance of the control loop; for this, the ITAE criterion is used to quantify performance. Equation 3 below defines the ITAE criterion:

$$ITAE = \text{?} t \vert e \vert dt \qquad ( 3 )$$

$$\text{?} \text{indicates text missing or illegible when filed}$$

where e is the autocorrelation error, calculated between the distance of the autocorrelation to the confidence interval. If the autocorrelation is within the confidence interval, an error is considered equal to 0. The variance of the autocorrelation error is one of the criteria for evaluating the performance of the control loop. The greater the variance, the greater the oscillation present in the control loop. Experiments determined a limit for this variance of 0.10. Above this limit, it is determined that there is oscillation.

The ISE criterion penalizes large errors, while the ITAE criterion penalizes errors that persist over time (the greater the oscillation in the time series, the more the oscillation will propagate in the autocorrelation function). For this reason, the ITAE criterion is used.

Combined with the ITAE criterion, the variance of the autocorrelation error and Levene's statistical test to evaluate the performance of control loops, the R² determination coefficient is used. R² is calculated to measure the fit of the output autocorrelation data with respect to the output autocorrelation axis and the R² with respect to the input autocorrelation and the input autocorrelation axis. The closer R² is to 1, the more oscillatory the control loop is.

The coefficient of determination is presented in Equation 4, in which N is the size of the input/output autocorrelation vector, yᵢ is the straight line of the input/output autocorrelation axis, ŷ₁ is the input/output autocorrelation vector and y̅ is the average of the values of the straight line of the input/output autocorrelation axis.

$${R}^{2} = 1 - \frac{\text{?} {( \text{?} )}^{2}}{\text{?} {( \text{?} - \text{?} )}^{2}} \qquad ( 4 )$$

$$\text{?} \text{indicates text missing or illegible when filed}$$

The last indicator proposed is Levene's statistical test. The Levene's statistical test assumes that two independent samples have the same variance; that is, the homogeneity of variances. For this, the null hypothesis H₀ assumes that σₐ²−σ_{b}²=0; that is, the variances of the two samples are not different. The other hypothesis, H₁, assumes that σₐ²−σ_{b}²≠0; that is, the variances of the two samples are different.

The rejection of the null hypothesis of Levene's statistical test indicates that the variances of the two groups are different and are not homogeneous. In this case, the p value is small. If Levene's statistical test indicates that the variances of the two groups are not different, the p value is large (Coccia, 2021).

The Levene's statistical test is calculated to evaluate the homogeneity between the output autocorrelation data and the output autocorrelation axis and the input autocorrelation data and the input autocorrelation axis in the IOCAD. If the test indicates homogeneity, the oscillation is diagnosed.

If the indicators (ITAE, R², error variance and Levene's statistical test) exceed a limit defined for each of them, called limit value or threshold, it is said that there is oscillation in the time series. This limit value is considered as a tuning parameter for each indicator. If a small value is chosen, there is a greater risk of false alarms occurring; on the other hand, if a higher threshold value is defined, there will be a delay in diagnosing the oscillation. If only the limits of the control action are exceeded, the controller is said to have lost robustness; that is, the control action is oscillating so that the process output setpoint is maintained. On the other hand, if the process output limits are exceeded, the controller is said to have lost performance; that is, even without oscillation in the control action, it is not possible to maintain the setpoint. Finally, if both time series cross the limits, the loss of operational controllability of the control loop is defined.

The invention is used in a moving window format, in which the IOCAD, the ITAE autocorrelation criterion, the R², the autocorrelation error variance, and the Levene's statistical test are updated online and with each new measurement. This application of the IOCAD, the ITAE autocorrelation criterion, the R², the variance of the autocorrelation error, and the Levene's statistical test in a moving window is another distinguishing feature of this invention.

The ITAE autocorrelation criterion is sensitive to the size of the used data moving window; therefore, the defined ITAE limit must take into consideration the size of the data moving window, and the window size must be large enough to capture the dynamics of the time series and small to avoid problems such as computational cost and delay in detecting the oscillation. On the other hand, the variance of the autocorrelation error, the R² and the Levene's statistical test do not depend on the size of the moving window. R² varies between 0 and 1, and the closer it is to 1, the greater the presence of oscillation.

An example that requires rapid detection and at an early stage of oscillation is in offshore oil production wells. In these processes, the oscillation may indicate severe slug; i.e., intermittent flow of oil and gas in the oil pipeline. Table 1 below presents the ITAE criterion limit for three different moving window sizes for this example.

TABLE 1

| Moving Window Size (No. of points) | ITAE criterion limit |
|---|---|
| 150 | 500 |
| 600 | 13500 |
| 1200 | 50000 |

Specifically, the method for auditing and diagnosing control loops of the present invention comprises the following steps: (a) determining the size of a moving window for collecting data of a manipulated variable (input) and a controlled variable (output); (b) removing a bias from the input and output signal; (c) calculating an autocorrelation function for the input and output data in the given moving window; (d) creating an Input-Output Cross Autocorrelation Diagram (IOCAD) and evaluate whether the points are scattered within the confidence region or outside the confidence region, and (e) applying an ITAE criterion, R², autocorrelation error variance and statistical tests, such as the Levene's statistical test to quantify the performance of the control loop.

The present invention can also be used to compare the current control loop with the performance of a reference control loop. To do this, it is only necessary to know the controller parameters, and with a tuning method the reference plant model G_{ref}(s) can be easily obtained. With the controller and the reference plant model, it is possible, through simulations, to obtain the reference control action (reference input) and the reference output of the reference control loop. The autocorrelation function is calculated for u, u_{ref}, y and y_{ref}, and the IOCAD is generated in a moving window to update at each new time instant. The autocorrelation is used, because it normalizes the data between −1 and 1, making it a great option to compare the performance of the control loop, even if the real plant model is not known.

In order to quantify the performance of the control loop and the reference control loop, the ITAE criterion is calculated for each control action and each moving window output. The ITAE characteristic for setpoint change (SP), disturbance (D) and setpoint change plus disturbance (SP+D) is represented. To evaluate whether the control loop has superior or inferior performance in relation to the reference model, the ITAE area is calculated for each of the three situations (SP, D and SP+D); the performance index, KPI, of the control loop is defined according to Equation 5 below:

$$KPI = \frac{AreaITAE}{{AreaITAE}_{Ref}} \qquad ( 5 )$$

where AreaITAE is the ITAE area of the real control loop and AreaITAE_{Ref} is the ITAE area of the reference control loop. The calculation of both AreaITAE and AreaITAE_{Ref} is presented in Equation 6, in which t=(0, . . . , τₜ), wherein the total time for each of the three situations is evaluated (SP, D and SP+D).

$$Area = \text{?} ITAEd \text{?} \qquad ( 6 )$$

$$\text{?} \text{indicates text missing or illegible when filed}$$

According to tests carried out, if KPI is less than 0.8, it is assumed that the control loop has a superior performance in relation to the reference control loop; if KPI is greater than 1.2, it is assumed that there is discrepancy of G(s) and C(s) plant models. Therefore, the control loop has lower performance than the reference control loop, and if KPI is between 0.8 and 1.2, it is found that the control loop has similar performance to the reference control loop. The KPI is calculated for both the control action and the control loop output.

Furthermore, the present invention refers to another method of using the IOCAD; specifically, a method for comparing the performance of a current control loop that compares the performance of a current control loop, consisting of a controller and a real plant model, with a reference control loop, consisting of said controller and a reference plant model comprising the following steps: (a) obtaining, based on the controller parameters, a reference plant model with a controller tuning technique, and obtaining, through simulation, the output signal of the reference control loop; (b) determining the size of the moving window for collecting data of the manipulated variable (input) and the controlled variable (output) from the control loop and the reference control loop; (c) using a fourth-order low-pass filter, optionally, in measurements that present strong noise; (d) calculating the autocorrelation function for the input and output of the control loop and the reference control loop; (e) creating the IOCAD and compare the performance of the real control loop with the reference control loop; (f) applying an ITAE criterion quantifying the discrepancy between the real control loop and the ideal control loop; and (g) calculating the area of the real ITAE value and the area of the reference ITAE value by comparing performance through the KPI.

### Example of Embodiment/Tests/Results

To exemplify the potential of the present invention, there is described a preferred embodiment of the same using two databases. Specifically, offshore oil production wells require the immediate detection of oscillation to prevent severe slugs from occurring; i.e., intermittent flow of oil and gas in the oil pipeline. To test the method of the present invention, two databases were used: one using a discrete PID controller with data presented by Barreiros, Trierweiler and Farenzena (2021) and another using real data from a real oil well from the year 2019. Noise and gas lift disturbance were added to the simulated data to get closer to the real conditions of an oil well, and based on the detection of loss of operational controllability, two solutions are proposed: return to a stable setpoint or change the controller tuning. In these examples, the production choke valve is considered as a manipulated variable, and the PDG (Pressure Downhole Gauge), pressure at the base of the well, is an important variable to describe the dynamics of the offshore oil well, as a controlled variable.

The examples shown herein are intended only to exemplify one of the numerous embodiments of carrying out the method of the present invention, although without limiting its scope.

In the example using data from a real oil well, the moving window size used was 150 points, with a sampling time of 1 min (60 s), the limit ITAE considered was 500, the limit R² was 0.95, the autocorrelation error variance limit of 0.10. The limit p value of the initial Levene's statistical test is 0.025; however, once the limits of R², ITAE and variance are exceeded by both the manipulated variable and the controlled variable, the limit p value is autotuned to 0.01. In this case, a series of steps in the setpoint were made until reaching a region where the oscillation, both in the PDG and in the choke, increases, indicating that the slug region is close. Upon noticing the loss of process stability, the operator changed the setpoint to a stable region, approximately 145.5 bar (14.55 MPa). The increase in oscillation is observed in the interval between approximately 3200 s and 5800 s. When analyzing the IOCAD, in one of the tests carried out, it is concluded that the loss of operational controllability is identified in a moving window close to the beginning of the increase in oscillation, as the points are scattered along the 45 degree straight line, providing information on that the well is close to a slug region and must be brought to a stable setpoint, which actually occurred in this real operation. At approximately 5800 s, the setpoint is increased so that the control loop returns to the stable region. In another embodiment of the present invention, there is the ITAE criterion of the PDG autocorrelation and the choke autocorrelation. In a different embodiment of the present invention, it is possible to notice the autotuning of the limit p value when the other indicators are exceeded. The indicators exceed their respective thresholds as soon as the PDG reaches the new setpoint (143 bar-14.3 MPa), and the oscillation of the controlled variable and the manipulated variable begins to increase, diagnosing the loss of operational controllability of the control loop before the slug happens. In the previous moving windows, the choke autocorrelation and PDG autocorrelation indicators are below the limits, meaning that the control loop was performing well. It is concluded that R² exceeds the limit R² approximately at the same time that the limit ITAE is exceeded and the PDG autocorrelation error variance exceeds the variance limit. When the limit p value is reset, that is, the greater the chance of accepting the null hypothesis H₀, from Levene's statistical test, the p value of the PDG autocorrelation exceeds the new limit at the same time as the other indicators. The choke indicators exceed the limits a few moments later, confirming the loss of stability of the control loop. This example highlights the ability to detect in advance the loss of operational controllability of this invention, since the indicators R², ITAE, variance and the Levene's statistical test identified the region of operational instability before the real detection. It is also clear, in this embodiment, that ITAE and autocorrelation error variance are more sensitive to setpoint changes than R² and Levene's test.

The second example uses a discrete PID in the database presented by Barreiros, Trierweiler and Farenzena (2021), with the aim of simulating a real situation in which PDG and choke data are acquired and the methodology presented in this invention is calculated in real time, with the aim of avoiding the loss of operational controllability. To do this, disturbances are made in the gas lift so that the slug occurs. In another preferred embodiment of the present invention, it is clear that, from t=25 h (90000 s), the oscillation, both in the controlled variable and in the manipulated variable, increases until, at approximately t=45 h (162000 s), the slug occurs. Once the loss of operational controllability is detected, two solutions are proposed: return to a stable setpoint or change the controller tuning.

In this example, the moving window encompasses 600 data, with a sampling time of 10 s, with the limit ITAE defined as 13500, the limit R² as 0.95, and the autocorrelation error variance limit as 0.10. The limit p value of the initial Levene's statistical test is 0.025; however, once the limits of R², ITAE and variance are exceeded by both the manipulated variable and the controlled variable, the limit p value is autotuned to 0.01. When all indicators reach their limits, the setpoint is reset to a stable region. From the tests carried out, it is possible to conclude that the present invention is capable of detecting in advance the loss of operational controllability of the system. This detection takes place at approximately t=36 h (129600 s) and, from this point onwards, the setpoint is reset to a stable region and thus the system is stabilized.

The second proposed solution is to change the controller tuning. The parameters used were the same as the first proposed solution; therefore, the detection time for the loss of operational controllability is the same. The first instant in that the four indicators are above their respective limits, the controller tuning is changed. From the tests carried out, it is concluded that, by changing the controller tuning, it is also possible to stabilize the system, proving the effectiveness of this invention in detecting the loss of operational controllability.

In a preferred embodiment of the present invention, the methodology proposed in this invention is combined with a low-pass filter to reduce the effects of measurement and process noise, the case study being the same as that previously used. The parameters used were: moving window of 600 data, with a sampling time of 10 s, with the limit ITAE defined as 13500, the limit R² as 0.95 and the autocorrelation error variance limit as 0.10. The limit p value of the initial Levene's statistical test is 0.025; however, once the limits of R², ITAE and variance are exceeded by both the manipulated variable and the controlled variable, the limit p value is autotuned to 0.01. The filter used is of fourth order with a cutoff frequency of 150 Hz. Once the loss of operational controllability is detected and, consequently, the proximity of the slug in the oil well, the setpoint is reset to a stable region. In the test scenario, the loss of stability was detected in 30 h (108000 s), while in the scenario portrayed in the previous test the detection time was approximately 36 h (129600 s); that is, filtering noise helps the methodology proposed in this invention.

The tests carried out and presented exemplify situations wherein the system is losing controllability, as the process variable indicators exceed their limits before the manipulated variable indicators. However, there are cases in which the controller loses robustness, but maintains the desired setpoint. In these circumstances, the oscillation is present in the manipulated variable. Upon analyzing an additional test, it is clear that the MV indicators exceed their limits before the PV indicators, diagnosing the controller's loss of robustness. The parameters used were: moving window of 600 data, with a sampling time of 10 s, with the limit ITAE defined as 13500, the limit R² as 0.95, and the autocorrelation error variance limit as 0.10. The limit p value of the initial Levene's statistical test is 0.025; however, once the limits of R², ITAE and variance are exceeded by both the manipulated variable and the controlled variable, the limit p value is autotuned to 0.01. The filter used is of fourth order with a cutoff frequency of 150 Hz.

With the tests carried out presented, it is worth highlighting that R² is intuitive, it varies from 0 to 1 and, the closer to 1, the greater the oscillation, and it does not depend on the size of the moving window; in addition, R² is not sensitive to setpoint changes. The autocorrelation error variance also does not depend on the size of the moving window, whereas the ITAE criterion depends on the size of the moving window. Levene's statistical test is robust and intuitive, as well as R², but the test loses robustness for very large moving window sizes.

Another point highlighted is that these indicators can be used separately, with the R² and the Levene's statistical test being the most robust, followed by the variance of the autocorrelation error and the ITAE criterion.

Another category of the present invention relates to a method for comparing the performance of the control loop with a reference control loop. For this, a PID controller is used. The PID controller parameters are presented in Table 2 below.

TABLE 2

| Kₚ | σᵢ | τ_{d} |
|---|---|---|
| 1 | 8.8 | 2 |

With the PID controller parameters in hand, it is possible to obtain the reference plant model G_{Ref}(s) using a tuning method and obtain the response of the reference control loop through simulations. For the tests used in the present invention, the Internal Control Method (IMC) was used to obtain a second-order transfer function presented by Equation 7 below (Pereira, 2011).

$${G}_{Ref} ( s ) = \frac{1}{\text{?} + \text{?} + 1} \qquad ( 7 )$$

$$\text{?} \text{indicates text missing or illegible when filed}$$

Tests were carried out on 13 different plants, each with different characteristics, with dead time, inverse response, overshoot, etc. The tests carried out were setpoint (SP) step, disturbance (D) and setpoint and disturbance (SP+D) step with a moving window of 60 points. The plants were named from A to M and, in addition, tests were carried out multiplying the plants' gains by 100 and dividing the controller's gain by 100; the opposite was also done to verify the robustness of the methodology presented in this invention. Table 3 below presents the results for the outputs of the control loops, identified as KPI_{y} and for the plant control actions, identified as KPIᵤ. Plant outputs are presented and control actions are represented. When multiplying and dividing the gains of the plants and the controller, the result obtained was the same as in Table 3 and therefore will not be shown. For KPI less than 0.8, the real control loop is considered to have better performance than the reference control loop, while for KPI greater than 1.2, the real control loop has lower performance than the reference loop. KPI between 0.8 and 1.2 depicts control loops with identical performance.

TABLE 3

| | | |
|---|---|---|
| SP | D | SP + D |

| Plant | KPI_{y} | KPIᵤ | KPI_{y} | KPIᵤ | KPI_{y} | KPIᵤ |
|---|---|---|---|---|---|---|
| GA | 0.94 | 1.02 | 0.92 | 1.41 | 0.94 | 0.99 |
| GB | 0.91 | 0.82 | 0.76 | 0.84 | 0.91 | 0.98 |
| GC | 1.29 | 0.90 | 0.42 | 0.40 | 0.84 | 0.87 |
| GD | 1.25 | 0.76 | 0.39 | 0.46 | 0.82 | 0.65 |
| GE | 0.98 | 0.93 | 0.91 | 0.85 | 0.98 | 0.94 |
| GF | 0.81 | 0.97 | 0.62 | 1.19 | 0.80 | 0.62 |
| GG | 0.77 | 0.06 | 0.49 | 0.10 | 0.79 | 0.04 |
| GH | 0.96 | 0.63 | 0.35 | 0.53 | 0.78 | 0.57 |
| GI | 0.89 | 0.75 | 0.65 | 0.83 | 0.88 | 0.73 |
| GJ | 3.41 | 3.20 | 1.08 | 8.78 | 0.82 | 0.47 |
| GK | 1.77 | 2.94 | 1.25 | 4.69 | 1.58 | 2.78 |
| GL | 0.96 | 0.81 | 0.85 | 0.65 | 0.95 | 0.80 |
| GM | 0.79 | 0.14 | 0.50 | 0.15 | 0.78 | 0.15 |

Of these plants evaluated, GE, GK and GM stand out. From Table 3, it can be concluded that the GE plant has a performance similar to the reference model, the GK plant is inferior to the reference model, and the GM plant is superior to the reference model.

1. A method for auditing and diagnosing control loops based on quantifying oscillation in the manipulated variable and the controlled variable of the current control loop, characterized in that it comprises the following steps:
a. determining the size of a moving window for collecting data of a manipulated variable (input) and a controlled variable (output);
b. removing a bias from the input and output signal;
c. calculating an autocorrelation function for the input and output data in the given moving window;
d. creating an Input-Output Cross Autocorrelation Diagram (IOCAD) and evaluating whether the points are scattered within the confidence region or outside the confidence region; and
e. applying an ITAE criterion, R², autocorrelation error variance and statistical tests, such as Levene's statistical test, to quantify the performance of the control loop.

2. The method for auditing and diagnosing control loops according to claim 1, optionally comprising using a fourth-order low-pass filter in measurements that present strong noise.

3. The method for auditing and diagnosing control loops according to claim 1, characterized in that, in step (e), said statistical tests comprise Levene's statistical tests that quantify the performance of the control loop.

4. The method for auditing and diagnosing control loops according to claim 1, characterized in that the Input-Output Cross Autocorrelation Diagram (IOCAD) created in step (d) comprises an input that is the control action and an output that is the process variable.

5. The method for auditing and diagnosing control loops according to claim 1, characterized in that it uses a moving window on the input (manipulated variable) and output (controlled variable) data of the control loop.

6. The method for auditing and diagnosing control loops according to claim 1, characterized in that it uses a low-pass filter in cases with strong measurement and process noise in the moving window in the input (manipulated variable) and output (controlled variable) data of the control loop.

7. The method for auditing and diagnosing control loops according to claim 1, characterized by calculating an autocorrelation function of input (manipulated variable) and output (controlled variable) data of the control loop.

8. The method for auditing and diagnosing control loops according to claim 1, characterized in that the Input-Output Cross Autocorrelation Diagram generated in step (d) consists of an axis representing the input autocorrelation and another axis representing the output autocorrelation.

9. The method for auditing and diagnosing control loops according to claim 1, characterized in that, in step (c), it calculates the error between the input autocorrelation and its confidence interval and the error between the output autocorrelation and its confidence interval.

10. The method for auditing and diagnosing control loops according to claim 1, characterized in that it further comprises, in step (c), calculating the integral of the time-weighted error between the input autocorrelation of the control loop and its confidence interval, called ITAE of the input and, additionally, calculating the integral of the time-weighted error between the output autocorrelation of the control loop and its confidence interval, called ITAE of the output.

11. The method for auditing and diagnosing control loops according to claim 1, characterized in that it defines, in step (e), a limit ITAE value.

12. The method for auditing and diagnosing control loops according to claim 1, characterized in that it:
calculates the R² between the control loop input autocorrelation and the IOCAD input autocorrelation axis called input R²; and
calculates the R² between the control loop output autocorrelation and the IOCAD output autocorrelation axis called output R².

13. The method for auditing and diagnosing control loops according to claim 1, characterized in that it defines, in step (e), a limit R² value.

14. The method for auditing and diagnosing control loops according to claim 1, characterized in that it:
calculates the input autocorrelation error variance of the control loop, called input autocorrelation error variance; and
calculates the output autocorrelation error variance of the control loop, called output autocorrelation error variance.

15. The method for auditing and diagnosing control loops according to claim 1, characterized in that it defines a variance value of the limit autocorrelation error.

16. The method for auditing and diagnosing control loops according to claim 1, characterized in that it:
calculates statistical tests, such as Levene's statistical homogeneity test, between the control loop input autocorrelation and the IOCAD input autocorrelation axis, called the p value of the input, and between the control loop output autocorrelation and the IOCAD output autocorrelation axis, called p value of the output.

17. The method for auditing and diagnosing control loops according to claim 16, characterized in that it defines a limit p value for statistical tests.

18. The method for auditing and diagnosing control loops according to claim 1, characterized in that it:
compares the ITAE value of the input and/or output with the limit ITAE, the R² of the input and/or output with the limit R², the variance between the autocorrelation error of the input and/or output with the variance limit and the p value of the input and/or output with the limit p value; and
wherein, if both values are above the respective limits, the oscillation in the manipulated and/or controlled variable is detected.

19. A method for comparing the performance designed for the control loop, characterized in that it compares the performance of the current control loop, consisting of a controller and a real plant model, with a reference control loop, the performance of the reference control loop obtained through simulations, consisting of said controller and a reference plant model, and comprises the following steps:
a. obtaining, based on the controller parameters, a reference plant model with a controller tuning technique and obtain, through simulation, the output signal from the reference control loop;
b. determining the size of the moving window for collecting data of the manipulated variable (input) and the controlled variable (output) from the control loop and the reference control loop;
c. using a fourth-order low-pass filter, optionally, in measurements that present strong noise;
d. calculating the autocorrelation function for the input and output of the control loop and the reference control loop;
e. creating the IOCAD and comparing the performance of the real control loop with the reference control loop;
f. applying an ITAE criterion quantifying the discrepancy between the real control loop and the ideal control loop; and
g. calculating the area of the real ITAE value and the area of the reference ITAE value by comparing performance through the KPI.

20. The method for comparing the performance of a current control loop according to claim 19, characterized in that it obtains a reference plant model, based on controller parameters using a controller tuning technique.

21. The method for comparing the performance of a current control loop according to claim 19, characterized in that it uses a moving window in the input (manipulated variable) and output (controlled variable) data of the current control loop and reference control loop.

22. The method for comparing the performance of a current control loop according to claim 19, characterized in that it:
calculates an autocorrelation function of the input data (manipulated variable) and the output data (controlled variable) of the current control loop and reference control loop.

23. The method for comparing the performance of a current control loop according to claim 19, characterized in that it calculates a confidence interval of the input autocorrelation function and of the output autocorrelation function of the control loop.

24. The method for comparing the performance of a current control loop according to claim 19, characterized in that the created Input-Output Cross Autocorrelation Diagram comprises an axis representing the input autocorrelation and another axis representing the output autocorrelation.

25. The method for comparing the performance of a current control loop according to claim 19, characterized in that it:
calculates an error between the input autocorrelation and its confidence interval and the error between the output autocorrelation and its confidence interval; and
calculates an error between the reference input autocorrelation and its confidence interval and the error between the reference output autocorrelation and its confidence interval.

26. The method for comparing the performance of a current control loop according to claim 19, characterized in that it calculates an integral of the time-weighted error between the input autocorrelation and its confidence interval, called ITAE of the input; and
calculates an integral of the time-weighted error between the output autocorrelation and its confidence interval, called the ITAE of the output.

27. The method for comparing the performance of a current control loop according to claim 19, characterized in that it:
calculates an integral of the time-weighted error between the input autocorrelation of the reference control loop and its confidence interval called ITAE of the reference input; and
calculates an integral of the time-weighted error between the output autocorrelation of the reference control loop and its confidence interval called ITAE of the reference output.

28. The method for comparing the performance of a current control loop according to claim 19, characterized in that it:
calculates an ITAE area of the input and output upon a change of setpoint, a disturbance or a change of setpoint plus disturbance.

29. The method for comparing the performance of a current control loop according to claim 19, characterized in that it calculates an area of the ITAE of the reference input and output upon a change of setpoint, a disturbance or a change of setpoint plus disturbance.

30. The method for comparing the performance of a current control loop according to claim 19, characterized in that it calculates a KPI to determine whether the manipulated variable and/or the controlled variable of the control loop has a performance that is superior, inferior or similar to the reference control loop.
